(19) United States
(12) Patent Application Publication
(10) Pub. No.: US 2023/0107884 A1
(43) Pub. Date: Apr. 6, 2023

(54) SUSPENSION SYSTEM FOR A TRACKED VEHICLE

(71) Applicant: BAE Systems Hägglunds Aktiebolag, Örnsköldsvik (SE)

(72) Inventor: Rikard SUNDQUIST, Arnäsvall (SE)

(73) Assignee: BAE Systems Hägglunds Aktiebolag, Örnsköldsvik (SE)

(21) Appl. No.: 17/802,503

(22) PCT Filed: Feb. 17, 2021
(86) PCT No.: PCT/SE2021/050132

§ 371 Date: Aug. 25, 2022

(30) Foreign Application Priority Data
Feb. 27, 2020 (SE) 2050219-1

(51) Int. Cl. F41G 5/24; B62D 55/108; B62D 55/116

(52) U.S. Cl. CPC F41G 5/24; B62D 55/1083; B62D 55/116; F41H 7/02

(57) ABSTRACT

The present invention relates to a suspension system (S; S1; S2) fora tracked vehicle (V; V1; V2). Said tracked vehicle comprises a vehicle body (4), a pair of opposite track assemblies (T1, T2), the respective track assembly comprising a plurality of road wheels (2) and an endless track (3) disposed around said wheels. Said suspension system comprises a road wheel arm (20) having a wheel axle portion (22) configured to support a road wheel of the vehicle and a pivot axle portion (24), the road wheel arm (20) being pivotably journalled at said pivot axle portion (24) to a support portion (30) configured to be fixed to the vehicle body (4). The suspension system comprises a torsion bar (40) having a first end portion (42) and an opposite second end portion (44), the first end portion (42) being connected to the support portion (30). The suspension system comprises an adjustment device (100) connected to the second end portion (44) of the torsion bar (40), the adjustment device being configured to adjust the torque on the torsion bar so as to adjust the height of the vehicle body relative to said pair of track assemblies. The invention also relates to a tracked vehicle with such a suspension system and a method for controlling such a suspension system.

### TECHNICAL FIELD

The present invention relates to a suspension system for a tracked vehicle. The present invention also relates to a tracked vehicle. The present invention also relates to a method for controlling a suspension system of a tracked vehicle.

### BACKGROUND ART

Tracked vehicles such as military tracked vehicles may comprise a vehicle body and a pair of opposite track assemblies. Such military tracked vehicles may comprise a vehicle mounted weapon system, the weapon system comprising a gun barrel mounted to a turret via a gun barrel elevation device arranged to allow elevation movement of the gun barrel about an elevation axis.

The respective track assembly of such tracked vehicles comprises a drive wheel, a plurality of road wheels and an endless track disposed around said wheels. Such a tracked vehicle may comprise a suspension system comprising a road wheel arm for each road wheel. The road wheel arm has a wheel axle portion configured to support a road wheel of the vehicle and a pivot axle portion. The road wheel arm is pivotably journalled at said pivot axle portion to a support portion configured to be fixed to the vehicle body. The suspension system comprises a torsion bar having a first end portion being connected to the support portion and an opposite second end portion being connected on the opposite side of the vehicle body in connection to the opposite track assembly.

There is a need to present improvement in such suspension systems for tracked vehicles.

### OBJECTS OF THE INVENTION

An object of the present invention is to provide a suspension system for a tracked vehicle which facilitates operation of the vehicle.

Another object of the present invention is to provide a tracked vehicle comprising such a suspension system.

Another object of the present invention is to provide a method for controlling such a suspension system so as to facilitate vehicle operation.

### SUMMARY OF THE INVENTION

These and other objects, apparent from the following description, are achieved by a suspension system for a tracked vehicle, a tracked vehicle, and a method for controlling a suspension system of a tracked vehicle as set out in the appended independent claims. Preferred embodiments of the suspension system for a tracked a vehicle, the tracked vehicle and the method for controlling a suspension system of a tracked vehicle are defined in appended dependent claims.

Specifically an object of the invention is achieved by a suspension system for a tracked vehicle. Said tracked vehicle comprises a vehicle body and a pair of opposite track assemblies. The respective track assembly comprises a plurality of road wheels and an endless track disposed around said wheels. Said suspension system comprises a road wheel arm having a wheel axle portion configured to support a road wheel of the vehicle and a pivot axle portion. The road wheel arm is pivotably journalled at said pivot axle portion to a support portion configured to be fixed to the vehicle body. The suspension system comprises a torsion bar having a first end portion and an opposite second end portion. The first end portion being connected to the support portion. The suspension system comprises an adjustment device connected to the second end portion of the torsion bar. The adjustment device is configured to adjust the torque on the torsion bar so as to adjust the height of the vehicle body relative to said pair of track assemblies. Hereby efficient control of vehicle operation such as driving of the vehicle. Hereby efficient control of the suspension system may be obtained so as to facilitate controlling the height, i.e. level, of the vehicle body relative to the track assemblies of the vehicle. Thus hereby efficient control of the height, i.e. level, of the vehicle body relative to the track assemblies of the vehicle is facilitated.

According to an embodiment of the suspension system, the adjustment device is connected to the vehicle body. Hereby efficient adjustment of the torque of the torsion bar as well as holding of the torsion bar at an adjusted torque, i.e. pretension, of the torsion bar by means of the adjustment device may be obtained. The adjustment device may advantageously be an electric actuator such as an electric motor, servomotor or step motor. The adjustment device may advantageously be an electric device such as an electric motor, servomotor or step motor.

According to an embodiment of the suspension system, the adjustment device is operable between an adjustment mode for said torque adjustment on the torsion bar and a non-adjustment mode during which the adjustment device is configured to maintain the torque on the torsion bar. Hereby efficient control of the pretension of the torsion bar is facilitated.

According to an embodiment of the suspension system, the second end portion is connected to the adjustment device via a connecting element configured to be pivotably connected to the vehicle body. Hereby efficient adjustment of the torque of the torsion bar by means of the adjustment device is facilitated.

According to an embodiment of the suspension system, the connecting element is arranged on the opposite side of the vehicle body in connection to the opposite track assembly.

According to an embodiment the suspension system further comprises a torsion tube being arranged to surround at least a portion of the torsion bar, the torsion tube having a first end portion being fixedly connected to the connecting element and an opposite second end portion being connected to the second end portion of the torsion bar, wherein the connecting element is arranged at the support portion. Thus the connecting is arranged at the same side as the track assembly of the road wheel to which the associated road wheel arm is connected. Hereby the torsion bar does not need to run all the way between the left and right track assembly. Thus, hereby the torsion bar, as well as the torsion tube surrounding at least parts of the torsion bar, may be relatively short and extend just a portion of the distance between the pair of track assemblies. Hereby the connection of the torsion bar comprising support portion and connecting element may have the same configuration for the road wheels on both sides of the vehicle, i.e. for the road wheels of both the left and right track assembly. Hereby the road wheels for the left and right track assembly may be arranged so that opposite road wheels essentially axially coincide.

According to an embodiment of the suspension system, adjustment device is configured apply said torque on the connecting element so as to adjust the torque on the torsion bar. Hereby adjustment of the torque on the torsion bar by means of the adjustment device may be efficiently controlled.

According to an embodiment the suspension system comprises a control device configured to control the adjustment device. By thus having a control device configured to control the adjustment device control of the torque on the torsion bar, and thus control of the height of the vehicle body relative to track assemblies, may be efficiently obtained, and may be based on desired input information.

According to an embodiment of the suspension system, the control device is configured to control the adjustment device so as to control adjustment of the height of the vehicle body relative to said pair of track assemblies, wherein the second end portion is connected to the adjustment device via a connecting element configured to be pivotably connected to the vehicle body, wherein the control device is configured to control the adjustment device so that said adjustment device applies said torque on the connecting element so as to adjust the torque on the torsion bar, wherein the adjustment device is connected to the vehicle body. Hereby efficient adjustment of the torque of the torsion bar and efficient control of the adjustment, and thereby efficient control of the height of the vehicle body relative to track assemblies of the tracked vehicle, e.g. for advanced control such as aiming range of a gun barrel of the tracked vehicle may be obtained. According to an embodiment of the suspension system, the control device is configured to control the adjustment device so as to operate the adjustment device between an adjustment mode for controlling said adjustment device for said torque adjustment on the torsion bar and a non-adjustment mode during which the control device is configured to control the adjustment device so that the adjustment device maintains the torque on the torsion bar. Hereby efficient control of adjustment as well as holding of the torsion bar at an adjusted torque, i.e. pretension, of the torsion bar by means of the adjustment device is facilitated. This is also provides improvement for advanced control such as aiming range of a gun barrel of the tracked vehicle may be obtained. The adjustment device comprises an electric device, such as an electric motor, a servomotor or a step motor, wherein said control device is configured to control said electric device. Hereby easy control by means of the control device is obtained.

According to an embodiment of the suspension system, the control device is configured to control the adjustment device so as to control the aiming range of a gun barrel of the tracked vehicle. Hereby the aiming range relative to a target area may be increased, thus improving the operation of the gun barrel of a vehicle mounted weapon system comprising the gun barrel mounted to a turret via a gun barrel elevation device arranged to allow elevation movement of the gun barrel about an elevation axis.

According to an embodiment of the suspension system, the adjustment device comprises an electric actuator. The electric actuator may be an electric motor, a servomotor, a step motor or the like. Hereby efficient and easily controllable adjustment of the torque of the torsion bar by means of the adjustment device, i.e. electric actuator, may be obtained.

According to an embodiment of the suspension system, the adjustment device comprises an electric device. The electric device may be an electric motor, a servomotor, a step motor or the like. Hereby efficient and easily controllable adjustment of the torque of the torsion bar by means of the adjustment device, i.e. electric actuator, may be obtained.

According to an embodiment of the suspension system, the adjustment device is configured to adjust the torque on the torsion bar so as to adjust the height of the vehicle body relative to said pair of track assemblies, wherein the second end portion is connected to the adjustment device via a connecting element configured to be pivotably connected to the vehicle body, wherein the adjustment device is configured to apply said torque on the connecting element so as to adjust the torque on the torsion bar, wherein the adjustment device is connected to the vehicle body, wherein the adjustment device comprises an electric device, such as an electric motor, a servomotor or a step motor, wherein the adjustment device is operable between an adjustment mode for said torque adjustment on the torsion bar and a non-adjustment mode during which the adjustment device is configured to maintain the torque on the torsion bar, the suspension system comprising a control device configured to control the adjustment device. Hereby efficient adjustment of the torque of the torsion bar and efficient control of the adjustment, and thereby efficient control of the height of the vehicle body relative to track assemblies of the tracked vehicle, e.g. for advanced control such as aiming range of a gun barrel of the tracked vehicle may be obtained, as well as efficient control of holding of the torsion bar at an adjusted torque, i.e. pretension, of the torsion bar by means of the adjustment device.

Specifically an object of the invention is achieved by a tracked vehicle comprising a vehicle body, a pair of opposite track assemblies, the respective track assembly comprising a plurality of road wheels and an endless track disposed around said wheels, the tracked vehicle further comprising a suspension system as set out herein.

According to an embodiment of the tracked vehicle, the suspension system comprises a road wheel arm for each road wheel and adjustment devices connected to at least torsion bars for opposite rear and/or opposite front road wheels. Hereby efficient control and adjustment of the height and inclination of the vehicle body relative to the track assemblies of the vehicle may be obtained.

According to an embodiment of the tracked vehicle, the tracked vehicle comprises a vehicle mounted weapon system, the weapon system comprising a gun barrel mounted to a turret via a gun barrel elevation device arranged to allow elevation movement of the gun barrel about an elevation axis, wherein the torque of one or more or more torsion bars is configured to be adjusted by means of adjustment device so as to control the aiming range of the gun barrel. Hereby the aiming range relative to a target area may be increased, thus improving the operation of the gun barrel.

Specifically an object of the invention is achieved by a method for controlling a suspension system of a tracked vehicle. The tracked vehicle comprises a suspension system as set out herein. The tracked vehicle further comprises a vehicle mounted weapon system, the weapon system comprising a gun barrel mounted to a turret via a gun barrel elevation device arranged to allow elevation movement of the gun barrel about an elevation axis, the method comprising the step of adjusting the torque on one or more torsion bars so as to adjust the aiming range of the gun barrel. Hereby the aiming range relative to a target area may be increased, thus improving the operation of the gun barrel.

According to an embodiment of the method, the step of adjusting the torque on one or more torsion bars is based on direction of the gun barrel relative to the longitudinal extension of the vehicle and level of target area relative to the position of the vehicle. Hereby the aiming range relative to a target area may be further improved.

### BRIEF DESCRIPTION OF THE DRAWINGS

For a better understanding of the present invention reference is made to the following detailed description when read in conjunction with the accompanying drawings, wherein like reference characters refer to like parts throughout the several views, and in which:

FIG. 1 a schematically illustrates a side view of a tracked vehicle according to an embodiment of the present disclosure;

FIG. 1b schematically illustrates a plan view of the tracked vehicle in FIG. 1a according to an embodiment of the present disclosure;

FIG. 2 schematically illustrates a plan view of a tracked vehicle with a suspension system according to an embodiment of the present disclosure;

FIG. 3 schematically illustrates a plan view of a tracked vehicle with a suspension system according to an embodiment of the present disclosure;

FIG. 4 schematically illustrates a block diagram of a control device for controlling a suspension system according to an embodiment of the present disclosure;

FIG. 5 schematically illustrates a flow chart of a method for controlling a suspension system according to an embodiment of the present disclosure; and

FIG. 6 schematically illustrates a flow chart of a method for controlling a suspension system according to an embodiment of the present disclosure.

### DETAILED DESCRIPTION

Herein the term “link” refers to a communication link which may be a physical connector, such as an optoelectronic communication wire, or a non-physical connector such as a wireless connection, for example a radio or microwave link.

Herein the term “aiming range of gun barrel” comprises the range the gun barrel of the tracked vehicle may be elevated between a highest elevation angle and a lowest elevation angle, i.e. the elevation aiming range. The term “aiming range of gun barrel” may also comprise the traversing aiming range, i.e. azimuth aiming range, e.g. for a tracked vehicle having a turret with limited rotation capacity, e.g. less than 360 degrees. The term “aiming range” may also be denoted “aiming ability”. The term “aiming range” may also be denoted “aiming ability”.

Herein the term “target area” may refer to an area relative to the position of the tracked vehicle where a target may appear and where the gun barrel of the tracked vehicle is intended to aim. The term “target area” may comprise the term “target” referring to an actual target at which the gun barrel of the tracked vehicle is intended to be aimed.

Herein the term “adjustment device” refers to any suitable device for providing adjustment of torque provided by a torsion bar of a suspension system of a tracked vehicle, which torsion bar is connected to a road wheel of the vehicle. The adjustment device may e.g. comprise an electric device, comprising e.g. an electric motor, a servomotor, a step motor or the like.

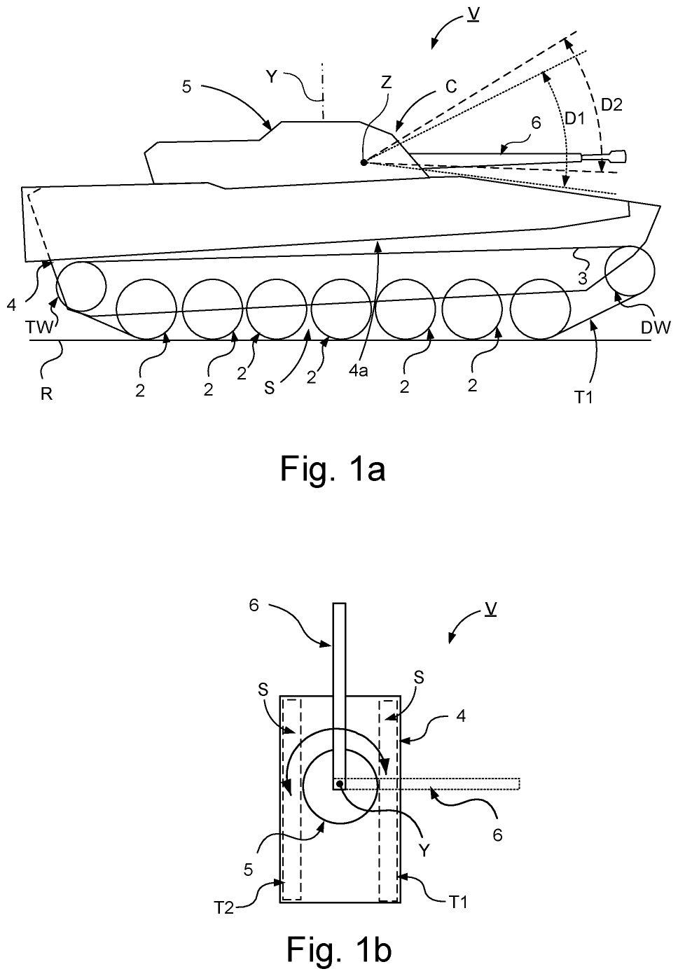

FIG. 1a schematically illustrates a side view of a tracked vehicle V according to an aspect of the present disclosure and FIG. 1b schematically illustrates a plan view of the vehicle V in FIG. 1a. The exemplified vehicle V is constituted by a combat vehicle. The tracked vehicle V comprises a vehicle body 4, which according to an aspect of the present disclosure comprises the chassis of the vehicle V and bodywork.

The tracked vehicle V comprises a track assembly pair T1, T2 being suspendedly connected to the vehicle body 4. The track assembly pair comprises a right track assembly T1 and a left track assembly T2 for driving the vehicle, each track assembly comprising a drive means driven endless track 3 arranged to run over a set of wheels 2 of the track assembly.

The tracked vehicle V comprises drive wheels DW, for the respective track assembly, wherein the endless track 3 is configured to be disposed also around the drive wheel DW. The respective drive wheel DW is configured to be driven by means of the drive means so as to drive the endless track 3 for driving the vehicle V. The drive wheel DW is arranged in the front of the respective track assembly. The tracked vehicle comprises tension wheels TW for the respective track assembly, wherein the endless track is configured to be disposed also around the tension wheel TW. The tension wheel TW is arranged in the rear of the respective track assembly.

According to an aspect of the present disclosure, the vehicle V is equipped with a turret 5. The turret 5 is arranged on top of the vehicle V. The turret 5 is rotatable about an axis Y of rotation orthogonal to the longitudinal extension of the vehicle V and orthogonal to the transversal extension of the vehicle V.

According to an aspect of the present disclosure, the vehicle V is configured to be equipped with a weapon system C having a gun barrel 6. The gun barrel 6 is mounted to the turret 5. The gun barrel 6 of the weapon system C is thus allowed to rotate by means of rotating the turret 5 about the axis Y.

According to an aspect of the present disclosure, gun barrel 6 is configured to be connected to a gun barrel elevation device, e.g. a weapon cradle, connected to the turret 5. The gun barrel 6 is configured to be raised and lowered, i.e. provide an elevation movement, about an elevation axis Z, see FIG. 1a, by means of the gun barrel elevation device. The gun barrel 6 may be elevated within a certain elevation span, thus providing a certain aiming range D1, D2. The gun barrel 6 may be elevated between a highest elevation angle and a lowest elevation angle, thus providing a certain aiming range. The gun barrel 6 thus has a certain aiming range relative to the turret 5.

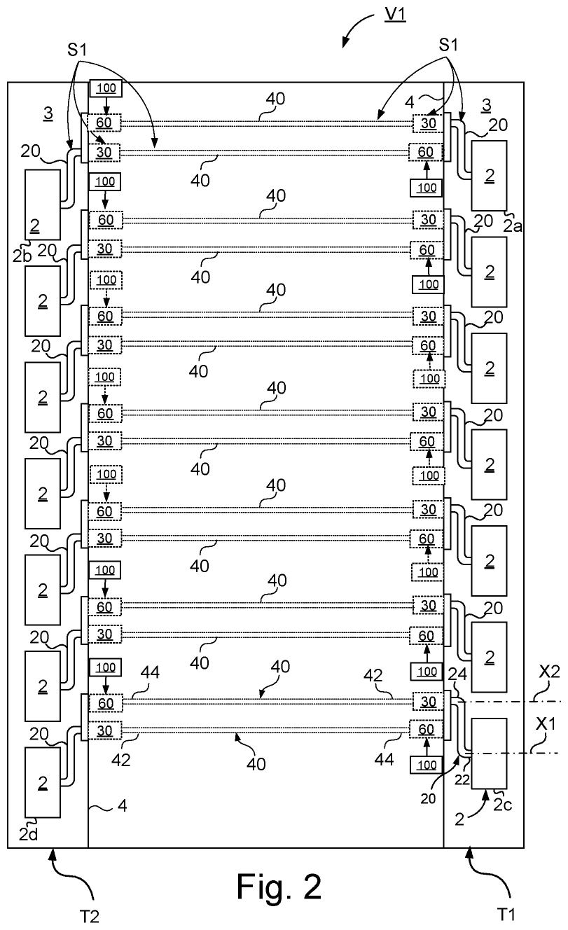

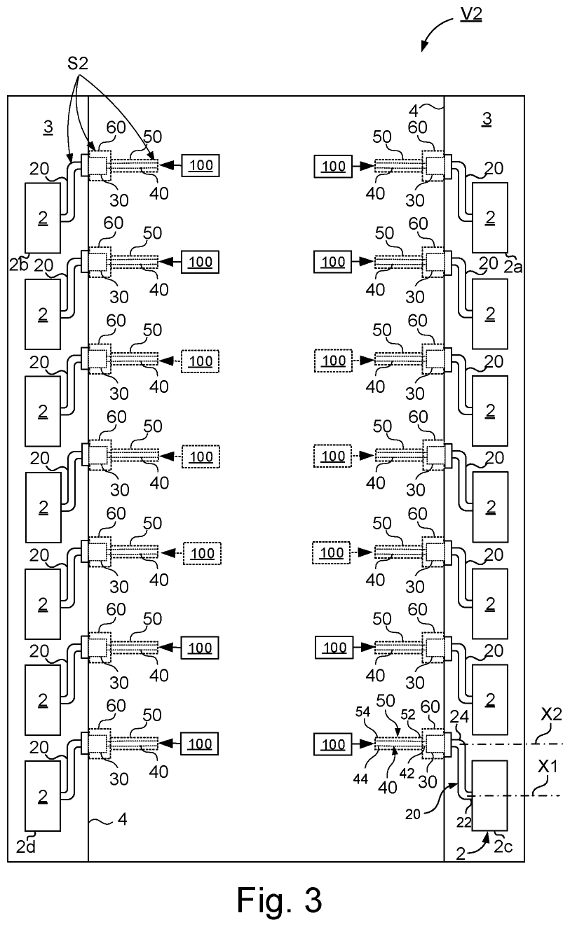

The tracked vehicle V comprises a suspension system S. Embodiments of the suspension system according to the present disclosure are described below with reference to FIGS. 2 and 3.

The suspension system comprises a road wheel arm, not shown in FIG. 1a-b, for each road wheel. The suspension system comprises torsion bars, not shown in FIG. 1a-b, connected to the road wheel arms. The torsion bars may be provided with a certain pretension for providing suspension of the vehicle body 4 relative to the track assemblies not shown in FIG. 1a-b, T1, T2. The suspension system S comprises adjustment devices, not shown in FIG. 1a-b, connected to at least torsion bars for opposite rear and/or opposite front road wheels, configured to adjust the torque on the torsion bar so as to adjust the height of the vehicle body 4 relative to said pair of track assemblies T1, T2.

According to an aspect of the present disclosure, the torque of one or more or more torsion bars is configured to be adjusted by means of adjustment device so as to control the aiming range of the gun barrel 6. In FIG. 1a the front portion of the vehicle body 4 has been raised and/or rear portion of vehicle body 4 lowered by means of adjustment devices, so that the aiming range has been changed from an aiming range D1 to an aiming range D2 in which the highest level of the gun barrel has been increased, facilitating aiming at a target on a higher level relative to the vehicle.

If the gun barrel 6 is pointing e.g. in a direction orthogonal to the longitudinal extension of the vehicle V as dotted in FIG. 1b, a corresponding adjustment of the aiming range may be obtained by raising the right side of the vehicle body 4 and/or lowering the left side of the vehicle body 4 by means of adjusting the torque of torsion bars by means of adjustment devices of the suspension system.

FIGS. 2 and 3 below illustrates tracked vehicles V1, V2 with suspension systems S1, S2 according to aspects of the present disclosure, said suspension systems S1, S2 comprising adjustment devices 100 configured to adjust torque on torsions bars 40 so as to adjust the height of the vehicle body relative to the pair of track assemblies T1, T2. The tracked vehicle V may comprise such a suspension system S1, S2. Hereby the ride height of the vehicle may be efficiently adjusted.

Thus, according to an aspect of the present disclosure, the suspension system S; S1; S2 of the tracked vehicle V; V1; V2 according to the present disclosure comprises adjustment devices 100 configured to adjust torque on torsions bars 40 so as to adjust the ride height of the tracked vehicle.

According to an aspect of the present disclosure, the adjustment devices may be configured to adjust torque on torsions bars based on possible inclination of the ground on which the vehicle is travelling so as to adjust the inclination of the vehicle body relative to the ground so as to reduce the leaning angle of the vehicle body of the tracked vehicle while driving on a side slope and/or level out the vehicle so as to improve driveability of the tracked vehicle.

FIG. 2 schematically illustrates a plan view of a tracked vehicle V1 with a suspension system S1 according to an embodiment of the present disclosure. The tracked vehicle V1 may be a tracked combat vehicle, e.g. as disclosed with reference to FIG. 1a-b.

Said tracked vehicle V1 comprises a vehicle body 4 and a pair of opposite track assemblies T1, T2. The respective track assembly T1, T2 comprises a plurality of road wheels 2 and an endless track 3 disposed around said wheels 2. In FIG. 2 only road wheels 2 are illustrated. The tracked vehicle comprises a first track assembly T1 constituting the right track assembly, and a second track assembly T2 constituting the left track assembly.

The tracked vehicle V1 may comprise drive wheels, not shown, for the respective track assembly, wherein the endless track is configured to be disposed also around the drive wheel. The drive wheel may be arranged in the front of the respective track assembly. The tracked vehicle may also comprise tension wheels, not shown, for the respective track assembly, wherein the endless track is configured to be disposed also around the tension wheel. The tension wheel may be arranged in the rear of the respective track assembly.

The road wheels 2 indicated with reference numbers 2a and 2b constitute a front road wheel pair of the tracked vehicle V1 and the wheels indicated with reference numbers 2c and 2d constitute a rear road wheel pair of the tracked vehicle V1. The first track assembly T1 has a front road wheel 2a and a rear road wheel 2c and a set of road wheels 2 there between. The second track assembly T2 has a front road wheel 2b and a rear road wheel 2d and a set of road wheels 2 there between.

Said suspension system S1 comprises a road wheel arm 20 for each road wheel 2. The respective road wheel arm 20 has a wheel axle portion 22 configured to support a road wheel 2 of the vehicle and a pivot axle portion 24. The road wheel arm 20 is pivotably journalled at said pivot axle portion 24 to a support portion 30 configured to be fixed to the vehicle body 4. The support portion 30 may be any suitable member configured to support the torsion bar 40. The support portion 30 may be a housing configuration or the like fixedly connected to the vehicle body 4 and configured to receive the pivot axle portion 24 of the road wheel arm 20.

According to an aspect of the present disclosure, the suspension system S1 comprises a torsion bar 40 for the respective road wheel 2. The suspension system S1 comprises a torsion bar 40 having a first end portion 42 and an opposite second end portion 44. Thus, each torsion bar 40 has a first end portion 42 and an opposite second end portion 44. The first end portion 42 of the torsion bar is connected to the support portion 30. The first end portion 42 of the torsion bar may be connected to the support portion 30 by means of a joint such as a spline joint.

According to the embodiment of the suspension system S1 illustrated in FIG. 2, the second end portion 44 of the torsion bar 40 is connected to a connecting element 60 configured to be pivotably connected to the vehicle body 4. The connecting element 60 is arranged on the opposite side of the vehicle body 4 in connection to the opposite track assembly.

Thus, for a torsion bar 40 where the first end portion 42 is connected to a support portion 30 to which a pivot axle portion 24 of a road wheel arm 20 of a road wheel 2, e.g. rear road wheel 2c, of the first track assembly T1 is pivotably journalled, the torsion bar 40 is configured to run transversely relative to the longitudinal extension of the tracked vehicle V1 to the opposite side of the vehicle body 4 in connection to the second track assembly T2, wherein the second end portion 44 of that torsion bar 40 is connected to the connecting element 60 connected to the vehicle body 4 and arranged in connection to the second track assembly T2. The first end portion 42 of the torsion bar 40 is thus configured to be connected to the support portion 30 of the rear road wheel 2c of the first track assembly T1 and the opposite second end portion 44 is configured to be connected to the connecting element 60 on the opposite side in connection to the second track assembly T2 and associated with the rear road wheel 2d of the second track assembly T2.

Correspondingly, for the torsion bar 40 where the first end portion 42 is connected to a support portion 30 to which a pivot axle portion 24 of a road wheel arm 20 of a road wheel 2, e.g. rear road wheel 2d, of the second track assembly T2 is pivotably journalled, the torsion bar 40 is configured to run transversely relative to the longitudinal extension of the tracked vehicle V1 to the opposite side of the vehicle body 4 in connection to the first track assembly T2, wherein the second end portion 44 of that torsion bar 40 is connected to the connecting element 60 connected to the vehicle body 4 and arranged in connection to the first track assembly T1. The first end portion 42 of this torsion bar 40 is thus configured to be connected to the support portion 30 of the rear road wheel 2d of the second track assembly T2 and the opposite second end portion 44 is configured to be connected to the connecting element 60 on the opposite side in connection to the first track assembly T1 and associated with the rear road wheel 2c of the first track assembly T2.

Thus, for opposite road wheels 2, torsion bars 40 are configured to run parallel to each other.

The thus connected torsion bars 40 are configured to provide suspension for the associated road wheels 2. The thus connected torsion bars 40 are configured to provide suspension for the associated road wheels 2 by providing a certain pretension of the torsion bar 40. The thus connected torsion bars 40 are configured to be provided with a pretension for providing suspension for the associated road wheels 2. There is thus a certain torque associated with the respective torsion bar 40 when thus connected to the support portion 30 and connecting element 60.

The suspension system S1 comprises an adjustment device 100 connected to the second end portion of the torsion bar. The suspension system S1 comprises a road wheel arm 20 for each road wheel and adjustment devices 100 connected to at least torsion bars 40 for opposite rear and/or opposite front road wheels 2.

The adjustment device 100 is configured to adjust the torque on the torsion bar 40 so as to adjust the height of the vehicle body 4 relative to said pair of track assemblies T1, T2.

According to the embodiment of the suspension system S1 illustrated in FIG. 2, the second end portion 44 of the torsion bar 40 is connected to the adjustment device via the connecting element 60 configured to be pivotably connected to the vehicle body 4.

According to an aspect of the present disclosure, the adjustment device 100 is configured to be connected to the vehicle body 4. According to an aspect of the present disclosure, the adjustment device 100 is configured to be essentially fixedly connected to the vehicle body 4.

According to an aspect of the present disclosure, the adjustment device 100 is operable between an adjustment mode for said torque adjustment on the torsion bar 40 and a non-adjustment mode during which the adjustment device 100 is configured to maintain the torque on the torsion bar 40.

According to an aspect of the present disclosure, the adjustment device 100 may, in the adjustment mode, be configured to turn the torsion bar 40 so as to adjust the torque on the torsion bar 40. According to an aspect of the present disclosure, the adjustment device 100 may, in the adjustment mode, be connected to the torsion bar such that when the adjustment device 100 is operated, the current pretension of the torsion bar 40 is adjusted. According to an aspect of the present disclosure, the adjustment device 100 may, in the adjustment mode, be configured to turn the torsion connecting element 60 so as to adjust the torque on the torsion bar 40. According to an aspect of the present disclosure, the adjustment device 100 may, in the adjustment mode, be connected to the torsion bar 40 via the connecting element 60 such that when the adjustment device 100 is operated, the current pretension of the torsion bar 40 is adjusted.

According to an aspect of the present disclosure, the adjustment device 100 may, in the non-adjustment mode, be configured to hold the torsion bar 40 so as to maintain the torque on the torsion bar 40. According to an aspect of the present disclosure, the adjustment device 100 may, in the non-adjustment mode, be connected to the torsion bar such that the current pretension of the torsion bar 40 is maintained. According to an aspect of the present disclosure, the adjustment device 100 may, in the non-adjustment mode, be configured to hold the connecting element 60 so as to maintain the torque on the torsion bar 40. According to an aspect of the present disclosure, the adjustment device 100 may, in the non-adjustment mode, be connected to the torsion bar 40 via the connecting element 60 such that the current pretension of the torsion bar 40 is maintained.

According to an aspect of the present disclosure, the adjustment device 100 may comprise an electric device, such as an electric motor, a servomotor or a step motor, wherein the adjustment device 100 may be configured to adjust the torque on the torsion bar so as to adjust the height of the vehicle body relative to said pair of track assemblies, wherein the second end portion 44 is connected to the adjustment device 100 via the connecting element 60 configured to be pivotably connected to the vehicle body 4, wherein the adjustment device 100 is configured apply said torque on the connecting element 60 so as to adjust the torque on the torsion bar 40, wherein the adjustment device 100 is connected to the vehicle body 4.

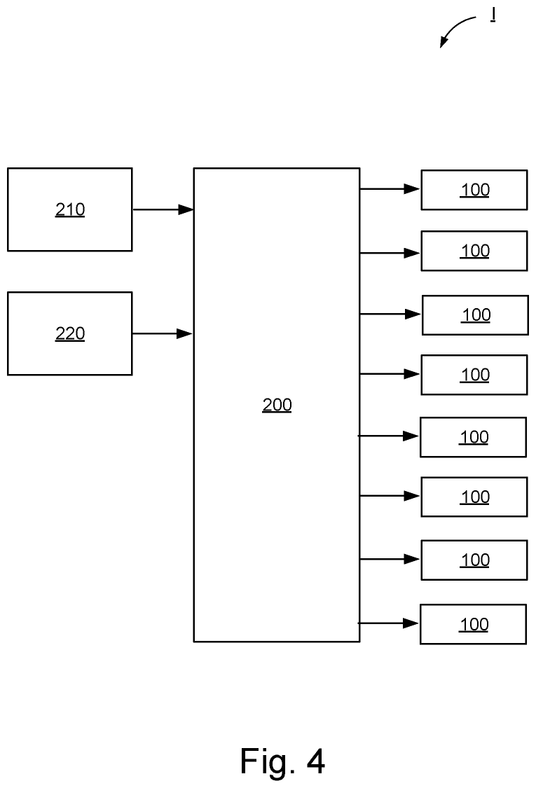

According to an aspect of the present disclosure, the suspension system S1 may comprise a control device, not shown, configured to control the adjustment device. The control device may be any suitable control device, e.g. a control device as described with reference to FIG. 4.

According to an aspect of the present disclosure, the control device may be configured to control the adjustment device 100 so as to control adjustment of the height of the vehicle body 4 relative to said pair of track assemblies, wherein the second end portion 44 is connected to the adjustment device via a connecting element 60 configured to be pivotably connected to the vehicle body 4, wherein the control device is configured to control the adjustment device 100 so that said adjustment device 100 applies said torque on the connecting element 60 so as to adjust the torque on the torsion bar 40, wherein the adjustment device 100 is connected to the vehicle body 4.

According to an aspect of the present disclosure, the control device may be configured to control the adjustment device 100 so as to operate the adjustment device 100 between said adjustment mode for controlling said adjustment device 100 for said torque adjustment on the torsion bar 40 and a non-adjustment mode during which the control device may be configured to control the adjustment device 100 so that the adjustment device 100 maintains the torque on the torsion bar 40.

According to an aspect of the present disclosure, the suspension system S1 may comprise a control device configured to control the adjustment device so as to control the aiming range of a gun barrel of the tracked vehicle V1.

FIG. 3 schematically illustrates a plan view of a tracked vehicle V2 with a suspension system S2 according to an embodiment of the present disclosure. The tracked vehicle V2 may be a tracked combat vehicle, e.g. as disclosed with reference to FIG. 1a-b.

Said tracked vehicle V1 comprises a vehicle body 4 and a pair of opposite track assemblies T1, T2. The respective track assembly T1, T2 comprises a plurality of road wheels 2 and an endless track 3 disposed around said wheels 2. In FIG. 2 only road wheels 2 are illustrated. The tracked vehicle comprises a first track assembly T1 constituting the right track assembly, and a second track assembly T2 constituting the left track assembly.

The tracked vehicle V2 may comprise drive wheels, not shown, for the respective track assembly, wherein the endless track is configured to be disposed also around the drive wheel. The drive wheel may be arranged in the front of the respective track assembly. The tracked vehicle may also comprise tension wheels, not shown, for the respective track assembly, wherein the endless track is configured to be disposed also around the tension wheel. The tension wheel may be arranged in the rear of the respective track assembly.

The road wheels 2 indicated with reference numbers 2a and 2b constitute a front road wheel pair of the tracked vehicle V2 and the wheels indicated with reference numbers 2c and 2d constitute a rear road wheel pair of the tracked vehicle V2. The first track assembly T1 has a front road wheel 2a and a rear road wheel 2c and a set of road wheels 2 there between. The second track assembly T2 has a front road wheel 2b and a rear road wheel 2d and a set of road wheels 2 there between.

Said suspension system S2 comprises a road wheel arm 20 for each road wheel 2. The respective road wheel arm 20 has a wheel axle portion 22 configured to support a road wheel 2 of the vehicle and a pivot axle portion 24. The road wheel arm 20 is pivotably journalled at said pivot axle portion 24 to a support portion 30 configured to be fixed to the vehicle body 4. The support portion 30 may be any suitable member configured to support the torsion bar 40. The support portion 30 may be a housing configuration or the like fixedly connected to the vehicle body 4 and configured to receive the pivot axle portion 24 of the road wheel arm 20.

According to an aspect of the present disclosure, the suspension system S2 comprises a torsion bar 40 for the respective road wheel 2. The suspension system S2 comprises a torsion bar 40 having a first end portion 42 and an opposite second end portion 44. Thus, each torsion bar 40 has a first end portion 42 and an opposite second end portion 44. The first end portion 42 of the torsion bar is connected to the support portion 30. The first end portion 42 of the torsion bar may be connected to the support portion 30 by means of a joint such as a spline joint.

According to an aspect of the present disclosure, the suspension system S2 comprises a connecting element 60 configured to be pivotably connected to the vehicle body 4. The connecting element 60 is, according to this aspect of the present disclosure, configured to be arranged at the support portion 30. The connecting element 60 may thus be configured to be arranged coaxially with the pivot axel portion 24 of the road wheel arm 20.

According to an aspect of the present disclosure, the suspension system S2 comprises a torsion tube 50. According to an aspect of the present disclosure, the suspension system S2 comprises a torsion tube 50 for the respective road wheel 2. The torsion tube 50 is arranged to at least partly surround the torsion bar 40.

The torsion tube 50 has a first end portion 52 configured to be fixedly connected to the connecting element 60. The torsion tube 50 has an opposite second end portion 54 configured to be connected to the second end portion 44 of the torsion bar 40. The second end portion 54 of the torsion tube 50 is, according to an aspect, configured to be fixedly connected to the second end portion 44 of the torsion bar 40.

Thus, for a torsion bar 40 where the first end portion 42 is connected to a support portion 30 to which a pivot axle portion 24 of a road wheel arm 20 of a road wheel 2, e.g. rear road wheel 2c, of the first track assembly T1 is pivotably journalled, the torsion bar 40 is configured to run transversely relative to the longitudinal extension of the tracked vehicle V2 a certain distance towards the opposite side, said certain distance being less than half the distance to the opposite side of the vehicle body 4 at the location of the second track assembly T2. The second end portion 44 of that torsion bar 40 is thus projecting said certain distance and is fixedly connected to the second end portion 54 of the torsion tube 50, e.g. by means of a spline joint. The first end portion 52 of the torsion tube 50 is configured to be fixedly connected to the connecting element 60. The torsion bar 40 and surrounding torsion tube 50 are thus coaxially arranged relative to the pivot axel portion 24 of the road wheel arm 20 of the rear road wheel 2c.

Correspondingly, for the torsion bar 40 where the first end portion 42 is connected to a support portion 30 to which a pivot axle portion 24 of a road wheel arm 20 of a road wheel 2, e.g. rear road wheel 2d, of the second track assembly T2 is pivotably journalled, the torsion bar 40 is configured to run transversely relative to the longitudinal extension of the tracked vehicle V2 a certain distance towards the opposite side, said certain distance being less than half the distance to the opposite side of the vehicle body 4 at the location of the first track assembly T1. The torsion bar 40 and surrounding torsion tube 50 are thus coaxially arranged relative to the pivot axel portion 24 of the road wheel arm 20 of the rear road wheel 2d of the second track assembly T2, and coaxially arranged relative to the torsion bar 40 and surrounding torsion tube 50 for the opposite rear road wheel 2c. The opposite road wheels 2 of the vehicle V2 may thus hereby be coaxially arranged relative to each other.

The thus connected torsion bars 40 and associated torsion tubes 50 are configured to provide suspension for the associated road wheels 2. The thus connected torsion bars 40 and associated torsion tubes 50 are configured to provide suspension for the associated road wheels 2 by providing a certain pretension of the torsion bar 40. The thus connected torsion bars 40 are configured to be provided with a pretension for providing suspension for the associated road wheels 2. There is thus a certain torque associated with the respective torsion bar 40 when thus connected to the support portion 30 and connecting element 60.

The suspension system S2 comprises an adjustment device 100 connected to the second end portion 44 of the torsion bar 40. The suspension system S2 comprises a road wheel arm 20 for each road wheel 2 and adjustment devices 100 connected to at least torsion bars 40 for opposite rear and/or opposite front road wheels 2.

The adjustment device 100 is configured to adjust the torque on the torsion bar 40 so as to adjust the height of the vehicle body 4 relative to said pair of track assemblies T1, T2.

According to the embodiment of the suspension system S2 illustrated in FIG. 3, the second end portion 44 of the torsion bar 40 is connected to the adjustment device via the connecting element 60 configured to be pivotably connected to the vehicle body 4. The second end portion 44 of the torsion bar 40 may be connected to the adjustment device 100 via the torsion tube 50, e.g. second end portion 54 of the torsion tube 50.

According to an aspect of the present disclosure, the adjustment device 100 is configured to be connected to the vehicle body 4. According to an aspect of the present disclosure, the adjustment device 100 is configured to be essentially fixedly connected to the vehicle body 4.

According to an aspect of the present disclosure, the adjustment device 100 is operable between an adjustment mode for said torque adjustment on the torsion bar 40 and a non-adjustment mode during which the adjustment device 100 is configured to maintain the torque on the torsion bar 40.

According to an aspect of the present disclosure, the adjustment device 100 may, in the adjustment mode, be configured to turn the torsion bar 40 so as to adjust the torque on the torsion bar 40. According to an aspect of the present disclosure, the adjustment device 100 may, in the adjustment mode, be connected to the torsion bar such that when the adjustment device 100 is operated, the current pretension of the torsion bar 40 is adjusted. According to an aspect of the present disclosure, the adjustment device 100 may, in the adjustment mode, be configured to turn the torsion tube 50 so as to turn the connecting element 60 so as to adjust the torque on the torsion bar 40. According to an aspect of the present disclosure, the adjustment device 100 may, in the adjustment mode, be connected to the torsion bar 40 via the torsion tube 50 and connecting element 60 such that when the adjustment device 100 is operated, the current pretension of the torsion bar 40 is adjusted.

According to an aspect of the present disclosure, the adjustment device 100 may, in the non-adjustment mode, be configured to hold the torsion bar 40 so as to maintain the torque on the torsion bar 40. According to an aspect of the present disclosure, the adjustment device 100 may, in the non-adjustment mode, be connected to the torsion bar such that the current pretension of the torsion bar 40 is maintained. According to an aspect of the present disclosure, the adjustment device 100 may, in the non-adjustment mode, be configured to hold the torsion tube 50 so as to hold the connecting element 60 so as to maintain the torque on the torsion bar 40. According to an aspect of the present disclosure, the adjustment device 100 may, in the non-adjustment mode, be connected to the torsion bar 40 via the torsion tube 50 and connecting element 60 such that the current pretension of the torsion bar 40 is maintained.

According to an aspect of the present disclosure, the adjustment device 100 may comprise an electric device, such as an electric motor, a servomotor or a step motor, wherein the adjustment device 100 may be configured to adjust the torque on the torsion bar so as to adjust the height of the vehicle body relative to said pair of track assemblies, wherein the second end portion 44 is connected to the adjustment device 100 via the connecting element 60 configured to be pivotably connected to the vehicle body 4, wherein the adjustment device 100 is configured apply said torque on the connecting element 60 so as to adjust the torque on the torsion bar 40, wherein the adjustment device 100 is connected to the vehicle body 4.

According to an aspect of the present disclosure, the suspension system S2 may comprise a control device, not shown, configured to control the adjustment device. The control device may be any suitable control device, e.g. a control device as described with reference to FIG. 4.

According to an aspect of the present disclosure, the control device may be configured to control the adjustment device 100 so as to control adjustment of the height of the vehicle body 4 relative to said pair of track assemblies, wherein the second end portion 44 is connected to the adjustment device via a connecting element 60 configured to be pivotably connected to the vehicle body 4, wherein the control device is configured to control the adjustment device 100 so that said adjustment device 100 applies said torque on the connecting element 60 so as to adjust the torque on the torsion bar 40, wherein the adjustment device 100 is connected to the vehicle body 4.

According to an aspect of the present disclosure, the control device may be configured to control the adjustment device 100 so as to operate the adjustment device 100 between said adjustment mode for controlling said adjustment device 100 for said torque adjustment on the torsion bar 40 and a non-adjustment mode during which the control device may be configured to control the adjustment device 100 so that the adjustment device 100 maintains the torque on the torsion bar 40.

According to an aspect of the present disclosure, the suspension system S2 may comprise a control device configured to control the adjustment device so as to control the aiming range of a gun barrel of the tracked vehicle V2.

FIG. 4 schematically illustrates a block diagram of a control device 200 for controlling a suspension system S of a tracked vehicle according to an embodiment of the present disclosure.

Said tracked vehicle comprises a vehicle body and a pair of opposite track assemblies. The respective track assembly comprises a plurality of road wheels and an endless track disposed around said wheels. Said suspension system comprises a road wheel arm having a wheel axle portion configured to support a road wheel of the vehicle and a pivot axle portion. The road wheel arm is pivotably journalled at said pivot axle portion to a support portion configured to be fixed to the vehicle body. The suspension system comprises a torsion bar having a first end portion and an opposite second end portion. The first end portion being connected to the support portion. The suspension system comprises an adjustment device connected to the second end portion of the torsion bar. The adjustment device is configured for adjusting the torque on the torsion bar so as to adjust the height of the vehicle body relative to said pair of track assemblies. According to an aspect of the present disclosure, the suspension system of the tracked vehicle comprises a road wheel arm for each road wheel and adjustment devices 100 connected to at least torsion bars for opposite rear and/or opposite front road wheels.

According to an aspect of the present disclosure, the control device 200 may be configured to control the adjustment device 100 so as to control adjustment of the height of the vehicle body relative to said pair of track assemblies, wherein the second end portion is connected to the adjustment device via a connecting element configured to be pivotably connected to the vehicle body, wherein the control device 200 is configured to control the adjustment device 100 so that said adjustment device 100 applies said torque on the connecting element so as to adjust the torque on the torsion bar, wherein the adjustment device 100 is connected to the vehicle body.

According to an aspect of the present disclosure, the control device 200 may be configured to control the adjustment device 100 so as to operate the adjustment device 100 between said adjustment mode for controlling said adjustment device 100 for said torque adjustment on the torsion bar and a non-adjustment mode during which the control device 200 may be configured to control the adjustment device 100 so that the adjustment device 100 maintains the torque on the torsion bar 40.

The tracked vehicle further comprises a vehicle mounted weapon system, the weapon system comprising a gun barrel mounted to a turret via a gun barrel elevation device arranged to allow elevation movement of the gun barrel about an elevation axis, the method comprising the step of adjusting the torque on one or more torsion bars so as to adjust the aiming range of the gun barrel.

The control device 200 is configured to control the adjustment devices 100 so as to control the aiming range of the gun barrel of the tracked vehicle.

The control device 200 for controlling the adjustment devices 100 may be comprised in a system I for controlling the adjustment devices so as to control the aiming range of the gun barrel of the tracked vehicle.

The control device 200 may be implemented as a separate entity or distributed in two or more physical entities. The control device 200 may comprise one or more computers. The control device 200 may thus be implemented or realised by the control device comprising a processor and a memory, the memory comprising instructions, which when executed by the processor causes the control device to perform the herein disclosed method.

The control device 200 may comprise one or more electronic control units, processing units, computers, server units or the like for controlling adjustment devices 100 of an articulated tracked vehicle during operation of the vehicle. The control device 200 may comprise control device such as one or more electronic control units arranged on board a vehicle. The control device 200 may comprise one or more electronic control units of the vehicle.

The control device 200 is configured to control one or more adjustment devices 100 based on direction of the gun barrel relative to the longitudinal extension of the vehicle and level of target area relative to the position of the vehicle so as to control the aiming range of the gun barrel of the tracked vehicle.

According to an aspect of the present disclosure the system I for controlling the adjustment devices so as to control the aiming range of the gun barrel of the tracked vehicle comprises a gun barrel direction determination device 210 for determining the direction of the gun barrel relative to the longitudinal extension of the vehicle. The gun barrel direction determination device 210 may comprise any suitable device comprising any suitable sensor or the like for determining the direction of the gun barrel relative to the longitudinal extension of the vehicle.

According to an aspect of the present disclosure the system I for controlling the adjustment devices so as to control the aiming range of the gun barrel of the tracked vehicle comprises a target area level determination device 220 for determining the level of a target area relative to the position of the vehicle. The target area level determination device 220 may comprise any suitable device comprising any suitable sensor such as camera or the like for determining the level of a target area relative to the position of the vehicle.

According to an aspect of the present disclosure, the control device 200 may, via a link, be operably connected to the gun barrel direction determination device 210. According to an aspect of the present disclosure, the control device 200 may via the link be arranged to receive one or more signals from the gun barrel direction determination device 210 representing data about direction of the gun barrel relative to the longitudinal extension of the vehicle.

According to an aspect of the present disclosure, the control device 200 may, via a link, be operably connected to the target area level determination device 220. According to an aspect of the present disclosure, the control device 200 may via the link be arranged to receive one or more signals from the target area level determination device 220 representing data about level of a target area relative to the position of the vehicle.

According to an aspect of the present disclosure, the control device 200 may be configured to process the data about direction of the gun barrel relative to the longitudinal extension of the vehicle and data about level of a target area relative to the position of the vehicle so as to determine required torque adjustment of one or more torsion bars for adjusting the aiming range of the gun barrel such that it is increased for the current direction of the gun barrel and level of the target.

According to an aspect of the present disclosure, the control device 200 may, via one or more links, be operably connected to one or more adjustment devices 100. According to an aspect of the present disclosure, the control device 200 may via the one or more links be arranged to send one or more signals to the one or more adjustment devices representing data about adjusting the torque on one or more torsion bars so as to adjust the aiming range of the gun barrel. According to an aspect of the present disclosure, the control device 200 may via the one or more links be arranged to send one or more signals to the one or more adjustment devices representing data about adjusting the torque on one or more torsion bars so as to adjust the height of the vehicle body of the tracked vehicle relative to the pair of track assemblies of the tracked vehicle.

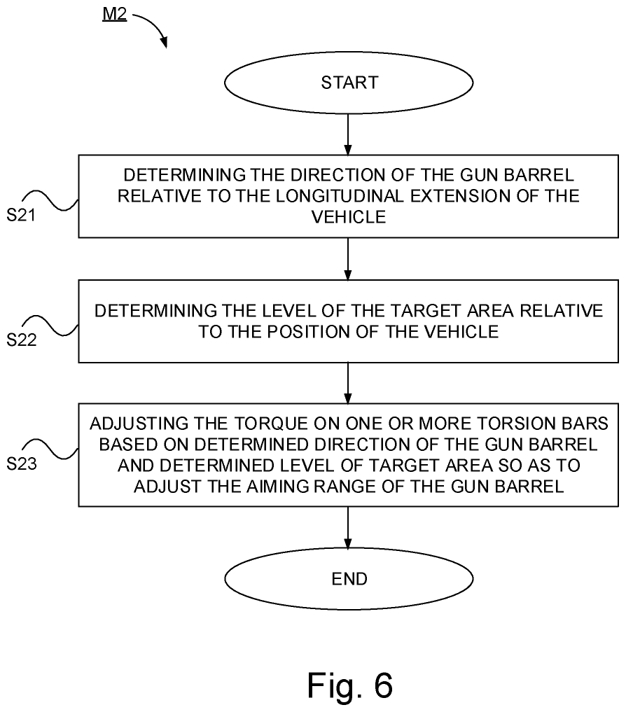

The control device 200 for controlling a suspension system of a tracked vehicle is, according to an embodiment, adapted to perform the method M1 described below with reference to FIG. 6.

The control device 200 for controlling a suspension system of a tracked vehicle is, according to an embodiment, adapted to perform the method M2 described below with reference to FIG. 7.

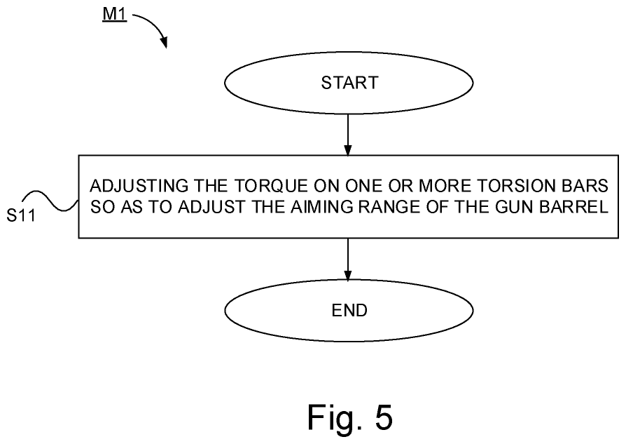

FIG. 5 schematically illustrates a flow chart of a method M1 for controlling a suspension system of a tracked vehicle according to an embodiment of the present disclosure.

Said tracked vehicle comprises a vehicle body and a pair of opposite track assemblies. The respective track assembly comprises a plurality of road wheels and an endless track disposed around said wheels. Said suspension system comprises a road wheel arm having a wheel axle portion configured to support a road wheel of the vehicle and a pivot axle portion. The road wheel arm is pivotably journalled at said pivot axle portion to a support portion configured to be fixed to the vehicle body. The suspension system comprises a torsion bar having a first end portion and an opposite second end portion. The first end portion being connected to the support portion. The suspension system comprises an adjustment device connected to the second end portion of the torsion bar. The adjustment device is configured for adjusting the torque on the torsion bar so as to adjust the height of the vehicle body relative to said pair of track assemblies. According to an aspect of the present disclosure, the suspension system of the tracked vehicle comprises a road wheel arm for each road wheel and adjustment devices connected to at least torsion bars for opposite rear and/or opposite front road wheels.

According to an aspect of the present disclosure, the second end portion of the torsion bar is connected to the adjustment device via a connecting element configured to be pivotably connected to the vehicle body. According to an aspect of the present disclosure, the adjustment device is configured apply said torque on the connecting element so as to adjust the torque on the torsion bar so as to adjust the height of the vehicle body relative to said pair of track assemblies. According to an aspect of the present disclosure, the adjustment device is configured to be connected to the vehicle body. According to an aspect of the present disclosure, the adjustment device comprises an electric device, such as an electric motor, a servomotor or a step motor. According to an aspect of the present disclosure, the adjustment device is operable between an adjustment mode for said torque adjustment on the torsion bar and a non-adjustment mode during which the adjustment device is configured to maintain the torque on the torsion bar. According to an aspect of the present disclosure, the suspension system comprises a control device configured to control the adjustment device. According to an aspect of the present disclosure, the adjustment device is configured to be controlled by means of a control device.

The tracked vehicle further comprises a vehicle mounted weapon system, the weapon system comprising a gun barrel mounted to a turret via a gun barrel elevation device arranged to allow elevation movement of the gun barrel about an elevation axis, the method comprising the step of adjusting the torque on one or more torsion bars so as to adjust the aiming range of the gun barrel.

According to the embodiment the method comprises a step S11. In this step the torque on one or more torsion bars is adjusted so as to adjust the aiming range of the gun barrel.

The step S11 may be performed by means of an adjustment device such as the adjustment device as set out herein.

FIG. 6 schematically illustrates a flow chart of a method M2 for controlling a suspension system of a tracked vehicle according to an embodiment of the present disclosure.

Said tracked vehicle comprises a vehicle body and a pair of opposite track assemblies. The respective track assembly comprises a plurality of road wheels and an endless track disposed around said wheels. Said suspension system comprises a road wheel arm having a wheel axle portion configured to support a road wheel of the vehicle and a pivot axle portion. The road wheel arm is pivotably journalled at said pivot axle portion to a support portion configured to be fixed to the vehicle body. The suspension system comprises a torsion bar having a first end portion and an opposite second end portion. The first end portion being connected to the support portion. The suspension system comprises an adjustment device connected to the second end portion of the torsion bar. The adjustment device is configured for adjusting the torque on the torsion bar so as to adjust the height of the vehicle body relative to said pair of track assemblies. According to an aspect of the present disclosure, the suspension system of the tracked vehicle comprises a road wheel arm for each road wheel and adjustment devices connected to at least torsion bars for opposite rear and/or opposite front road wheels.

According to an aspect of the present disclosure, the second end portion of the torsion bar is connected to the adjustment device via a connecting element configured to be pivotably connected to the vehicle body. According to an aspect of the present disclosure, the adjustment device is configured apply said torque on the connecting element so as to adjust the torque on the torsion bar so as to adjust the height of the vehicle body relative to said pair of track assemblies. According to an aspect of the present disclosure, the adjustment device is configured to be connected to the vehicle body. According to an aspect of the present disclosure, the adjustment device comprises an electric device, such as an electric motor, a servomotor or a step motor. According to an aspect of the present disclosure, the adjustment device is operable between an adjustment mode for said torque adjustment on the torsion bar and a non-adjustment mode during which the adjustment device is configured to maintain the torque on the torsion bar. According to an aspect of the present disclosure, the suspension system comprises a control device configured to control the adjustment device. According to an aspect of the present disclosure, the adjustment device is configured to be controlled by means of a control device.

The tracked vehicle further comprises a vehicle mounted weapon system, the weapon system comprising a gun barrel mounted to a turret via a gun barrel elevation device arranged to allow elevation movement of the gun barrel about an elevation axis, the method comprising the step of adjusting the torque on one or more torsion bars so as to adjust the aiming range of the gun barrel.

According to the embodiment the method comprises a step S21. In this step the direction of the gun barrel relative to the longitudinal extension of the tracked vehicle is determined.

According to the embodiment the method comprises a step S22. In this step the level of the target area relative to the positon of the tracked vehicle is determined.

Step S21 and step S22 may be performed at essentially the same time, or one step after the other. Step S22 may thus be performed prior to step S21, essentially at the same time as step S21 or after step S21.

According to the embodiment the method comprises a step S23. In this step the torque on one or more torsion bars is adjusted based on determined direction of the gun barrel and determined level of target area so as to adjust the aiming range of the gun barrel.

The step S23 may be performed by means of an adjustment device such as the adjustment device as set out herein.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated.

1. A suspension system for a tracked vehicle, said tracked vehicle comprising a vehicle body, a pair of opposite track assemblies, the respective track assembly comprising a plurality of road wheels and an endless track disposed around said wheels, said suspension system comprising a road wheel arm having a wheel axle portion configured to support a road wheel of the vehicle and a pivot axle portion, the road wheel arm being pivotably journalled at said pivot axle portion to a support portion configured to be fixed to the vehicle body, the suspension system comprising a torsion bar having a first end portion and an opposite second end portion, the first end portion being connected to the support portion, wherein the suspension system comprises an adjustment device connected to the second end portion of the torsion bar, the adjustment device being configured to adjust the torque on the torsion bar so as to adjust the height of the vehicle body relative to said pair of track assemblies.

2. The suspension system according to claim 1, wherein the adjustment device is connected to the vehicle body.

3. The suspension system according to claim 1, wherein the adjustment device is operable between an adjustment mode for said torque adjustment on the torsion bar and a non-adjustment mode during which the adjustment device is configured to maintain the torque on the torsion bar.

4. The suspension system according to claim 1, wherein the second end portion is connected to the adjustment device via a connecting element configured to be pivotably connected to the vehicle body.

5. The suspension system according to claim 1, wherein the connecting element is arranged on the opposite side of the vehicle body in connection to the opposite track assembly.

6. The suspension system according to claim 4, further comprising a torsion tube being arranged to surround at least a portion of the torsion bar, the torsion tube having a first end portion being fixedly connected to the connecting element and an opposite second end portion being connected to the second end portion of the torsion bar, wherein the connecting element is arranged at the support portion.

7. The suspension system according to claim 4, wherein adjustment device is configured apply said torque on the connecting element so as to adjust the torque on the torsion bar.

8. The suspension system according to claim 1, the suspension system comprising a control device configured to control the adjustment device.

9. The suspension system according to claim 8, wherein the control device is configured to control the adjustment device so as to control the aiming range of a gun barrel of the tracked vehicle.

10. The suspension system according to claim 1, wherein the adjustment device comprises an electric motor.

11. A tracked vehicle comprising a vehicle body, a pair of opposite track assemblies, the respective track assembly comprising a plurality of road wheels and an endless track disposed around said wheels, the tracked vehicle further comprising a suspension system according to claim 1.

12. The tracked vehicle according claim 11, wherein the suspension system comprises a road wheel arm for each road wheel and adjustment devices connected to at least torsion bars for opposite rear and/or opposite front road wheels.

13. The tracked vehicle according to claim 11, wherein the tracked vehicle comprises a vehicle mounted weapon system, the weapon system comprising a gun barrel mounted to a turret via a gun barrel elevation device arranged to allow elevation movement of the gun barrel about an elevation axis, wherein the torque of one or more or more torsion bars is configured to be adjusted by means of adjustment device so as to control the aiming range of the gun barrel.

14. A method for controlling a suspension system, according to claim 1, of a tracked vehicle, the tracked vehicle comprising a vehicle mounted weapon system, the weapon system comprising a gun barrel mounted to a turret via a gun barrel elevation device arranged to allow elevation movement of the gun barrel about an elevation axis, the method comprising the step of adjusting the torque on one or more torsion bars so as to adjust the aiming range of the gun barrel.

15. The method according to claim 14, wherein the step of adjusting the torque on one or more torsion bars is based on direction of the gun barrel relative to the longitudinal extension of the vehicle and level of target area relative to the position of the vehicle.
